(19) United States
(12) Patent Application Publication
(10) Pub. No.: US 2017/0186058 A1
(43) Pub. Date: Jun. 29, 2017

(54) Process and Method to both Reduce Total Cost of Ownership and to Migrate from Proprietary, Insecure, Computing Platforms to Open, Inexpensive, Secure Computing Platforms

(71) Applicants: Duncan Charles Hare, Santa Ana, CA (US); David Hobbs, New Westminster (CA)

(72) Inventors: Duncan Charles Hare, Santa Ana, CA (US); David Hobbs, New Westminster (CA)

(21) Appl. No.: 15/217,341

(22) Filed: Jul. 22, 2016

Related U.S. Application Data
(60) Provisional application No. 62/271,967, filed on Dec. 28, 2015.

(51) Int. Cl. G06Q 30/06; H04L 29/06

(52) U.S. Cl. CPC G06Q 30/0601; H04L 63/1441

(57) ABSTRACT

This invention describes a process to migrate from an insecure, expensive proprietary IT infrastructure to a more secure, and inexpensive open source IT infrastructure. Design objectives include, Elimination of Computer Skilled on-site personnel, Elimination of licensing costs for proprietary software, Use of inexpensive commodity hardware platforms, and access to data solely through a “Remote Desktop” display screen (output) and keyboard (input).

### BACKGROUND OF THE INVENTION

Networking of computers and computerized equipment has led to substantial enhancements in the accessibility and distribution of data and information. Unfortunately this expansion of computing has also led to high costs of maintenance and an inadequate level of security from malicious software. While the network integration of geographically remote equipment is substantially facilitated by the Internet, the security of data, and the use of insecure software products has resulted in a huge increase in attempts to breach one's privacy and corrupt one's data, up to and including the use of such exploits as weapons (Stuxnet being a prime example).

A prime vector for such exploits are the combination of current Hardware and Software architectures in common use, from viruses introduced and launched in email, viruses introduced via USB devices, and via CD/DVD disks. The effectiveness of these computer viruses is a direct result of a failure to separate programs from computer data, in memory. IF programs and data occupied completely separate storage and memory spaces within the computer, tricking a computer into thinking that a space containing data (or, a malicious program, for example) was really an authorized program would be IMPOSSIBLE. All infection sources are currently effective because there is (and has been) no barrier between executable programs, data in an enterprise and data introduced through email, from a USB device or from a CD disk. This patent solves this problem.

While enterprises have some tools to bar such infections, laptops and other enterprise machines are still readily susceptible to viruses, and to data loss when the physical device is lost or stolen.

From the foregoing, it can be seen that a need exists for secure computing, where data is never outside the control of the enterprise, and data cannot enter the enterprise without passing through centrally managed state-of-the-art secure data filters and scanners. A need exists, to provide computing on a platform which is centrally secure from exploits, and on which an unknowing or careless user cannot compromise the physical security of the IT system. This invention facilitates securing the IT systems and reducing the cost of ownership by eliminating a key entry point for virus infections—the current desktop computers, connected directly to corporate files and databases.

This solution will not prevent a user from deliberately disclosing data to others; the solution to that is beyond the scope of this patent. This solution does, however, address the security dangers due to accidental or deliberate virus introduction into a computer attached to a corporate network.

### SUMMARY OF THE INVENTION

Currently-used computers require a large support staff, have high maintenance and upkeep costs, and are insecure. We describe an open-software layer which can be placed underneath the current systems, which can maintain the use of Microsoft Windows and its associated sunk training costs. At the same time, our platform can reduce support costs and establish a platform for migration to an open-standards web-browser-based application while both phasing out expensive proprietary infrastructure and providing a secure enterprise computing platform.

We accomplish this in a phased process:
1. Generate IT budget savings by replacing desktops with low-cost integrated devices, to eliminate desktop security problems, complexity and support costs. The most inexpensive method of performing the replacement is to make the change to commodity hardware during the normal replacement cycle, although the replacement may be performed at any time. After the hardware replacement, the end user will have a very inexpensive replacement unit, which obtains its software, data storage, and various updates via a central Windows server and a data server. We envision networked groups of servers for use in corporate installations. The replacement hardware will essentially enable a remote GUI to run, enabling the end user to access remote data and OS elements on the local computer.
2. Couple step(1) with centrally distributed software and remote help desk support to enable the centralization of both control of IT change management and end user support.
3. Provide depot maintenance of all end-user hardware—which eliminates the necessity of costly skilled on-site support personnel with hardware easily replaced (swapped out) by relatively unskilled personnel.
4. Generate further IT budget savings in addition to those from (1) to encourage the migration of applications during their redevelopment or redeployment cycles from being Windows-based to being browser-based and open-standards-based, to take advantage of the license cost savings that may be obtained by using open source software.

The value of this process is the elimination of costly proprietary products, replacing them with inexpensive commodity hardware and freely available open software, along with greater network security.

In addition to the lower costs of open software, the existence of the source code in the public domain provides a mechanism for the open inspection and verification of the source code as a check of the integrity of the software. Proprietary, or “closed” software, makes performing these checks more difficult, at a time when corporations and individuals are increasingly under pressure to verify that their computers are secure, and safe to use. We believe that reviewable open source software is fundamentally more secure, reliable, and safer to use than “closed” proprietary software, because the source code of the proprietary software cannot be examined for programming flaws.

Security is delivered because the new computing platform at the user's desk does not use local storage devices, such as USB sticks, hard disks, or CD/DVD/Bluetooth drives, which may be vulnerable to viruses. The desktop replacement unit currently uses USB for mouse and keyboard, but USB memory devices are not supported, so no data can be extracted from the desktop replacement, and no viruses can worm their way in from an infected USB stick, for example. All the data and program elements are kept on the network, and are kept separate from each other. The separation between data and programs, along with the OS being kept on the network and the OS files being marked “Read Only,” maximize security for the corporate network, and minimize the dangers of computer viruses and malware.

The fundamental intention of our platform is, to the extent possible, to reduce the total cost of ownership of corporate computing devices, by using a cheaper, more secure structure that maximizes security and minimizes maintenance costs. This is not to say that it is impossible to create a scenario in which some compromise might occur; we merely wish to assert that the opportunities for compromise are much reduced, using our security model. We believe that the chance for unintended compromise is very sharply reduced by using our methodology.

Our process is designed to work on networks using either existing desktop computers, or much less-expensive desktop replacement units. It will work most effectively using our low-cost system-on-a-chip computer boards, because they can be easily managed remotely, but our process will also work on desktop computers. We favor desktop replacement instead of using existing desktops, because the replacements minimize all the costs associated with maintaining a distributed desktop computer network.

### BRIEF DESCRIPTION OF THE DRAWINGS

FIG. 1 shows a typical current IT system, with windows desktops, and a variety of servers, Unix, PCs and mainframes. Very few “dumb terminals” remain in today's IT environment.

FIG. 2 shows the transition step to a secure, inexpensive computing environment, where desktop computer system units FIG. 1 07 are replaced by an inexpensive Unix-based SoC FIG. 2 06 (System on a Chip, such as a Raspberry Pi), which runs a Microsoft Windows Remote Desktop Client (such as Remmina, a Unix software package). The desktop client provides access to a Windows GUI running on a Windows Server, and which gives access to the World Wide Web either though a Web browser running on the Windows Server (such as: Internet Explorer, Chrome or Firefox) or a web browser running on the local Linux system (such as Iceweasel, a fork of the Firefox Web Browser).

FIG. 3 shows a possible final configuration after migration, wherein all applications are accessed via the Web Browser running on the desktop Linux system. At this stage, no applications with direct file or database access are running on the desktop, because the remotely-accessed open-source software has been deployed throughout the enterprise.

### DETAILED DESCRIPTION OF THE INVENTION

The Invention is viewed through the five design objectives of the platform:

1. Elimination of Computer Skilled on-site personnel

2. Elimination of licensing costs for proprietary software

3. Use of an inexpensive commodity hardware platform

4. Access to data solely through the “Remote Desktop” display screen (output) and keyboard (input).

5. Migration to an open-software “Web Application” based computing platform.

This description illustrates how each of the design criteria are met, and discusses a migration path for current systems and platforms to the secure platform described in this invention.

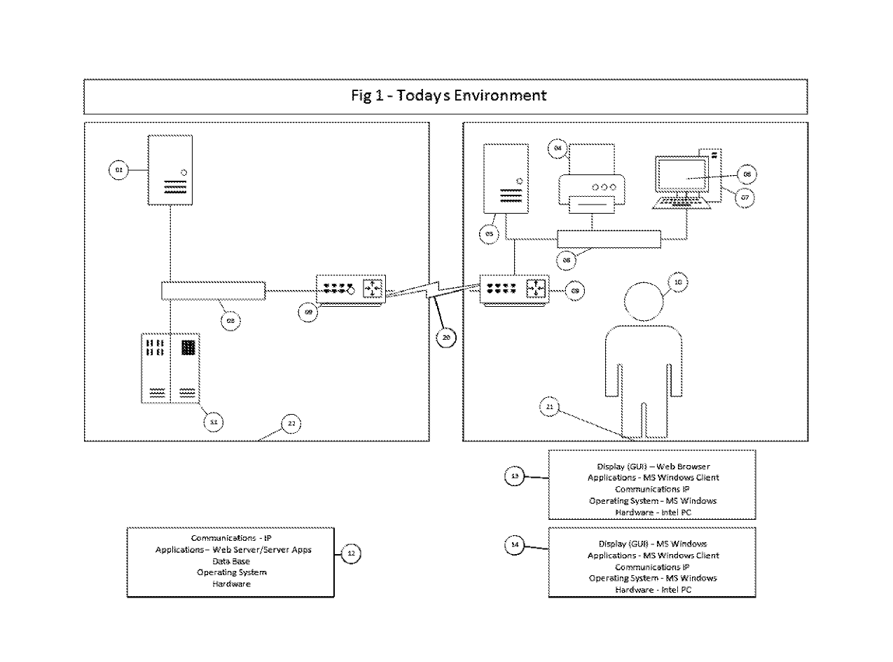

In today's environment, depicted in FIG. 1, Users 10 in a department 21, use a Personal Computer (PC), consisting of a System Unit 07 and display 06 with a keyboard and mouse (not depicted) typically plugged into a USB port on the system unit 07. The system unit is connected to the enterprise computing system by a Local Area Network (LAN) 08, which consists of cabling and a LAN Hub. Departmental servers 03, typically file and print servers, are connected to the LAN, and print servers manage printer jobs to enable sharing of departmental printers 04. The LAN is connected to the Wide Area Network (WAN) 20 by a Router 09. A second router in the data center connects the WAN to the Data Center, 22.

The Data Center 22, is connected to the user's department by the WAN 20, a second router 09 and a Data Center LAN 08. In this figure two classes of server are depicted, Legacy Mainframes 11, and a cluster of Web, Database and Applications rack-mounted servers 01.

Skilled Personnel. (Required in FIG. 1) Current corporate PC 21 installations require approximately one support technician for every 100 personal computers 06,07 deployed. These technicians are employed to keep the computers working, and to replace computers which have either software or hardware failures. The current fully-loaded cost of such a technician is approximately $100,000 per year, which translates to approximately $1,000 per desktop or laptop in use.

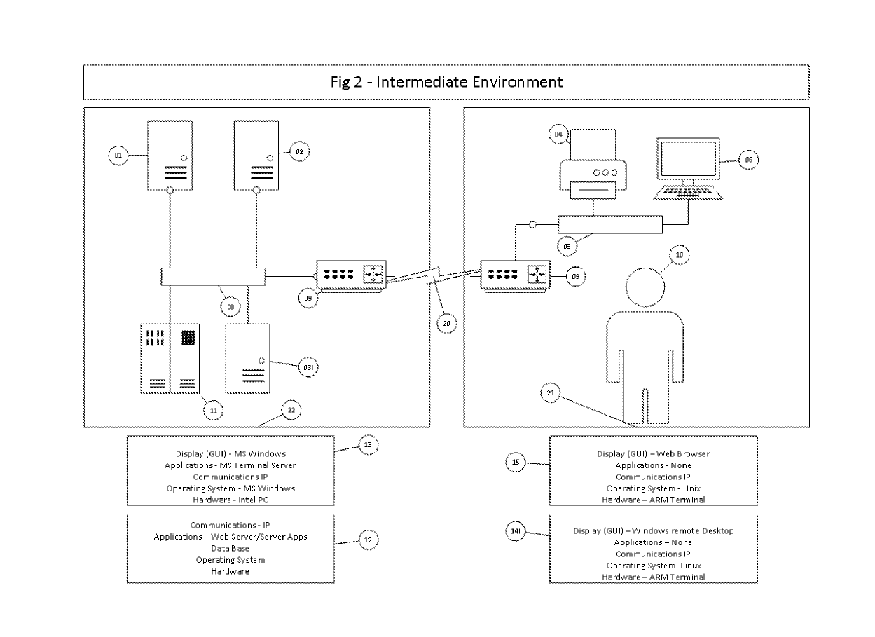

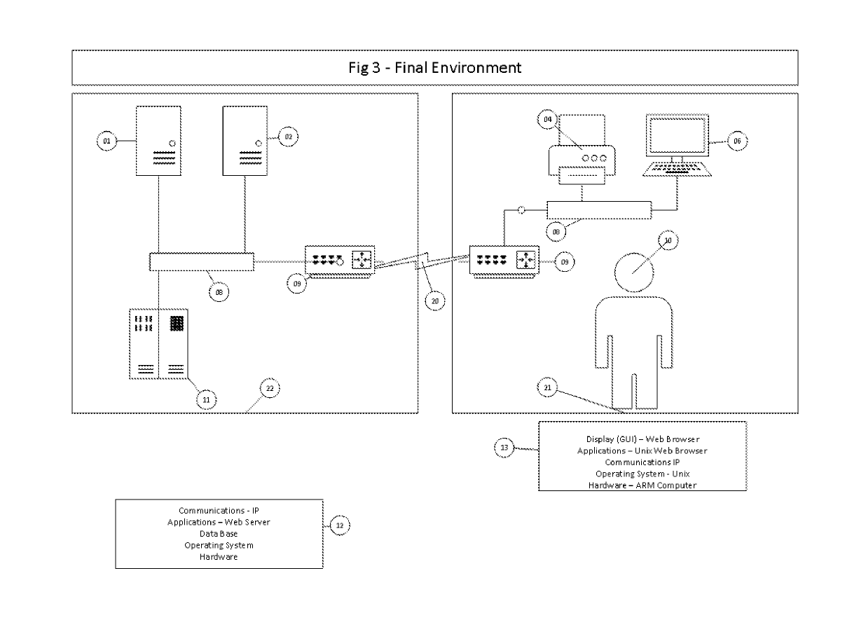

If these personal computer system units FIG. 1, 07 are replaced with a modern “dumb terminal” FIG. 2, 06, FIG. 3 06 available retail for approximately $50 per unit plus the cost of a display, keyboard and mouse, each replacement returns $950 in the first year of replacement. Of course, the display, keyboard, and mouse from the desktop installation may be used if compatible, with a concomitant reduction in costs.

For an enterprise which has an installed base of 50,000 replaceable PCs 07, this represents a potential savings of $47,500,000 over the corporate replacement cycle. In an enterprise which replaces personal computers on a three-year cycle, choosing to replace PCs with a low-cost desktop replacement unit at the scheduled time, the reduced costs of replacement result in a return of investment in one to two months.

Typically in an enterprise, management will opt for any course of action which has a return of investment time of less than 24 months, if the replacing supplier is considered “reputable.”

The SoC FIG. 2 06 which is at the heart of this process has shipped over 1 million units in the UK, and the chipset used in the SoC FIG. 2 06 is implemented in one of many forms, in billions of cellphones and tablets worldwide. The widespread use of these chips proves their ability to function as a portable computer, given suitable software.

Our SoC-based desktop replacements FIG. 2 06 use a variation of Debian, a widely-used Linux operating system; Ubuntu, an operating system that many have heard of, is also based on Debian. Debian has had a reputation for many years, among Linux users, as a reliable operating system.

The chosen hardware and software do much to eliminate the technology risk associated with the change process in this patent. Both the hardware and the software have proven themselves reliable over time.

Licensing Costs. (Incurred in FIG. 1) In large enterprises, PCs FIG. 1 07 are delivered with an installed operating system, and the cost of the operating system is bundled with the price of the computers. Enterprises may also install their own applications onto these machines for their specific needs. The section preceeding described the labor savings, operational expense, derived from the change to a modern “dumb terminal,” based on commodity hardware.

A similar calculation is possible for the cost of a Personal Computer FIG. 1 07 compared with the system-on-a-chip implementation. The cost to a corporation of a Personal Computer system unit FIG. 1 07 with software is approximately $500 and a SoC desktop replacement unit FIG. 2 06 approximately $50.

In an enterprise with 50,000 PCs FIG. 1 07 on a three yearly replacement cycle, just over 16,600 PCs are replaced each year at a capital costs of over $8,000,000. A SoC FIG. 2 06 replacement would cost under $800,000 for the same 16,000 desktops. Since the SoC FIG. 2 06 is being used as a dumb terminal, some enterprise servers would have to be added to the network, at an estimated cost of $3,000,000. Total savings (est.) $4,200,000. Once the desktops are replaced, one expects that the replacement schedule may slow significantly. The desktop replacements have no moving parts, and do not suffer from heat problems, because they use very little power—approximately 5 watts.

The first step in this process is to add Data Center servers FIG. 2 03I and FIG. 2 02 to deliver the Windows GUI servers FIG. 2 03I to the remote desktops, and Firmware Servers FIG. 2 03, with read only file systems for the Unix images which run the new “Dumb Terminals.”

The cost of the GUI servers FIG. 2 03I would be considered a one-time expense, because under the option of a full migration plan, an enterprise would be migrating all its applications to a Web Browser-based interface, eliminating the use of the Windows Remote desktop server in a single 3-year replacement cycle. The GUI servers FIG. 2 03I can be distributed among the main corporate locations, with backup servers defined in a backup planning document which is created as part of the migration strategy.

This final step is not essential to realize the savings generated. This final step eliminates the cost of upgrading the central proprietary software server over an extended period.

At the conclusion of the migration process, corporations have minimal-cost computer communications, with improved security because little or no operating system software resides on the desktop replacement unit. The software is in a remote server directory which is set as read only. Therefore, infecting a desktop PC and spreading a virus over the network becomes very difficult, and likely impossible without the collusion of network security staff. Our view is that virus infection becomes essentially impossible. It would be prudent to continue to be watchful, of course—but the danger from malware would drop very sharply indeed!

Commodity hardware platform. FIG. 2 06 As described above, the equipment used on a typical desktop would consist of a computer using an integrated System on a Chip (SoC) FIG. 2 06 device, plus a keyboard, mouse and display.

An example of such a system FIG. 2 03I would be a SoC-based FIG. 2 06 computer about the size of a pack of playing cards. (The SoC), with a USB keyboard and mouse, and an HDMI display, a variant of Linux (Raspbian), with the IceWeasel web browser and Remmina Remote Windows Desktop Applications, provides a complete desktop replacement. The desktop PC system unit FIG. 1 07 is desktop replacement unit, unlike a standard desktop PC, requires only a few watts of power.

The SoC FIG. 2 06 is based on the ARM chip design and is available today, retail for approximately $50 per unit, and the software is open source (free, but donations are invited).

Even if the enterprise was generous with its donations, at $5.00 per unit deployed, the cost of the system is an order of magnitude lower than comparable Intel-based PC costs, and cost reduction is only one of the benefits of this platform.

A mobile version of the remote desktop application is available for laptops, and its use would provide the required mobility of use, and eliminate the need for the laptop to contain any confidential or secret enterprise data.

An additional feature of this platform, not shown in the figures, is readily available remote help desk support for users, through the open-source product VNC. With this software, with the end user supplying the IP address of the ‘Dumb Terminal” support personnel can “see what the user sees” and guide the user through any issue.

Loss and Secured Portability

If an enterprise uses our process, a loss or theft of a laptop would be unlikely to cause a security breach or data loss, within the limitation that the laptop is only usable if there are Internet connections available. This trade-off is for the acquiring enterprise to evaluate. One advantage of this dumb terminal network model is that enterprise users often would not need to carry a laptop. By signing onto the network, all their applications and data would be instantly available from the network's servers, so they could use any terminal at any corporate office connected to the network, worldwide. Laptops are harder to secure than the desktop replacements, because laptops have attached I/O facilities—USB, firewire, CD/DVD/Bluetooth, built-in.

Secure Computing. (Shown in FIG. 2) Current computing platforms are poor at separating file storage from program and operating system storage. The file system is such that a data file can almost be placed anywhere in the file system, and an executable program can also be placed and executed from any location in the file system. This is bad storage design, because it facilitates malware.

In FIG. 2 06, the system unit in FIG. 1 07 is replaced with an SoC FIG. 2 06 which boots from its internal SD card, which in turn loads the read only Unix operating system from the Data Center Image server, FIG. 2 02. To protect the Boot information from corruption the first task of the read-only operating system is to perform a checksum of the boot partition, and if necessary, replace a corrupt boot segment with a legitimate boot partition, and then reboot the desktop replacement unit, or if there is an upgrade or downgrade required to the boot partition, then perform the upgrade or downgrade, and again reboot with the correct configuration.

The PC system in FIG. 1 07 is inherently insecure. Attempts to secure the system are always suspect because the security system added onto an unsecured platform may have flaws, allowing malicious software to breach security through an exploit, and compromise the Department file server FIG. 1 03, or Data Center server FIG. 1 01. Operating systems typically have millions of lines of program code, so there will always be programming mistakes that hackers can use to co-opt a computer, or a network of computers.

The system we describe has no connection between the computer user and the filesystem or database system other than the remote desktop. These remote systems, in our paradigm, do not permit file upload, so the computer user cannot upload a virus to the network or the server. The data is exchanged between the user on the database system in screen images to the user, and via mouse and keyboard from the user to the computer system.

This is not new. This is the same as legacy systems accessed through “dumb terminals” which were immune to viruses and other PC-based exploits.

User USB ports are unable to access Enterprise data by design. There is no provided data path from the “Dumb Terminal's” USB ports to the enterprise file system.

To send files to outside the enterprise, users would be required to attach them to emails, and send them through the email virus scanner now implemented in every enterprise. Similarly, files could be downloaded to email and shared, or placed on shared storage, with appropriate security protocols, (such as Dropbox, Google Drive, or equivalent).

By design we eliminate the possibility to create an exploit in the “Dumb Terminal's” FIG. 2 06)Unix firmware. This exploit path is removed by having the firmware image servers FIG. 2 02 physically separate from the terminal, and with file access to the image server FIG. 2 02 in the enterprise, and mounting the “Dumb Terminal's” FIG. 2 06 firmware file share in read only mode.

Central control of “Dumb Terminal” firmware also enables managed promotion and demotion of firmware images. The firmware server FIG. 2 02 can hold many variants of firmware, segregated by release level, device type, and capabilities, and the “Dumb Terminals” FIG. 2 06 can be configured to download only a specific file path on the server as their firmware. This greatly simplifies network-wide software updates, upgrades, and downgrades.

This form of change management is essential to manage a complex enterprise environment.

Web Based Enterprise (Shown in FIG. 3) The final step in this process is to move the enterprise to a complete web (web-browser-based) application delivery platform. This eliminates the cost of the proprietary software GUI and application server FIG. 2 031, and moves all enterprise application development to web-based tools, and eliminates the Remote Desktop application from end user “Dumb Terminals.”

Not all desktop PCs will be replaced, in the short term. Some legacy applications may be critical to an enterprise's day-to-day business, and budgets are always limited, so that complete “web migration” of all an Enterprise's applications may not immediately be feasible. However, without migrating every PC or workstation to a web based model, the enterprise would still enjoy much greater network security, along with very significant cost reductions, for every PC replaced by a Raspberry Pi, or equivalent desktop replacement unit.

It's worth noting, however, that even the legacy server programs popular in the 1960's eventually were replaced by desktops and smaller servers, because the value proposition of the new technology became unbeatable. The same will happen to the old legacy desktop applications, once again because of the value proposition of the new desktop replacement units and the reduced costs of network support, along with a significant increase in network security.

1) A process or replacing current computer equipment with System on a Chip (SoC) hardware and Open Source (Optional Contribution Funded) Software comprising the steps of:
a) Adding Central Microsoft Windows GUI, Print and Application Server(s) and User terminal Firmware/OS Server(s).
b) Configuring said Microsoft Window(s) Server with application and user login information
c) Adding the required firmware/OS images to the Firmware/OS server(s).
d) Replacing the User Personal Computers with SoC equipment,
e) which eliminates the need for Departmental Level User on-site personnel, by complete centralization of end user support and through remote access to end user terminals
f) and reduces the cost of End User equipment by 50% to 90%, and eliminates all or part of costly proprietary products, replacing them with freely available open software.

2) The process of claim 1, further providing greater network security, with Firmware corruption protected by read only file systems,
a) centralized promotion and demotion of changes,
b) with Increased network security due to removal of software from the desktop replacement, and requiring the software to be downloaded from a central, protected server,
c) with this migration process path to a secure computing platform
d) elimination of computer virus infection points in user departments, providing complete isolation of enterprise data from end user I/O devices,
e) elimination breach of security or exposure of confidential data on loss of correctly used laptops.

3) The process step of claim 1 and claim 2 leading to complete web based IT deployment, so providing the enterprise with the potential for a single application delivery mechanism to minimize application development and deployment costs.
